(19) United States
(12) Patent Application Publication
(10) Pub. No.: US 2018/0097376 A1
(43) Pub. Date: Apr. 5, 2018

(54) BATTERY PACK AND METHOD OF OPERATION THEREFOR

(71) Applicant: HYBRID POWER SOLUTIONS INC., Mississauga (CA)

(72) Inventor: Francois Renaud-Byrne, Mississauga (CA)

(21) Appl. No.: 15/284,261

(22) Filed: Oct. 3, 2016

(51) Int. Cl. H02J 7/00; H01M 2/34; H01M 10/48

(52) U.S. Cl. CPC H02J 7/0024; H02J 7/0021; H01M 2010/4271; H01M 10/486; H01M 2/348

(57) ABSTRACT

A battery pack and methods of operating the same are provided. The battery pack includes a battery, at least one sensor configured to read battery operation data, an external connection port, and a battery management system. The battery management system is coupled to the external and stores machine-executable instructions that, when executed, cause the battery management system to communicate battery operation data collected from the battery to an external load.

### FIELD

The following relates generally to electrical power. In particular, the following relates to a battery pack and a method of operation therefor.

### BACKGROUND OF THE DISCLOSURE

Battery packs are known, combining a number of battery cells, either in parallel, series, or a combination of both, to deliver a desired voltage, capacity, and/or power density. Rechargeable battery packs typically include a battery management system (“BMS”) that manages their recharging and operation, such as by protecting the battery pack from operating outside its safe operating conditions, monitoring its state, calculating secondary data, reporting that data, and controlling its environment. The battery management system uses various sensors to monitor the state of the battery, including a temperature sensor that is used by a battery charger to detect the end of charging.

Battery packs can include an external communication data port to enable a battery management system of the battery packs to communicate charge instructions to a smart battery charger. In this manner, the battery packs can maintain control of their charging.

Some proposed systems manage the power supply to external loads. One system includes one or more loads (i.e., devices) that communicate via a bus. A power source (either AC, or DC, such as battery packs) is coupled to the loads via a voltage regulator. The voltage regulator can adjust an input voltage level to a load based on information received from the load. Information about the load (for example, a power rating) is received by a voltage regulation controller. The load information can be received at start up and updated at any point. Independently, an input voltage is then received by the voltage regulator. The output load current is then determined based on the load information and the input voltage.

Other systems for managing a battery system for a system using a hierarchy to disconnect electrical loads from a battery system have been proposed. An input signal representing a condition of one of the components of the system is received by a battery management system via a controller area network (“CAN”), such as a CAN bus. The conditions can include, for example, the condition or state of the battery system, an electrical load, the temperature of the battery system, etc. The input signal is compared to at least one parameter to determine whether the condition indicates that at least one of the plurality of electrical loads should be disconnected from the battery. The battery management system can then direct an associated switch to be opened or closed, or can provide information about the condition of the battery system that may be displayed, used by another system, etc.

### SUMMARY OF THE DISCLOSURE

In one aspect, there is provided a battery pack, comprising a battery, at least one sensor configured to read battery operation data, an external connection port, and a battery management system coupled to the external connection port and storing machine-executable instructions that, when executed, cause the battery management system to communicate battery operation data collected from the battery to an external load.

The battery management system can be coupled to at least one sensor positioned to sense battery operation data.

The at least one sensor can comprise a thermal sensor.

The at least one sensor can comprise a voltage tap.

The at least one sensor can detect one of an amperage draw during discharge and an amperage accepted during charging.

The power provided by the battery pack can be shut down by the external load via the external connection port.

The battery pack can further comprise a contactor, and a control circuit coupled to the contactor and the external connection port enabling the external load to control the contactor.

The machine-executable instructions, when executed, can cause the battery management system to receive external load data from the external load.

The battery management system can modify its behavior in response to a request received in the external load data.

The battery management system can control a voltage provided to the external load in response to the request.

The battery management system can control a discharge amperage provided to the external load in response to the request.

In a further aspect, there is provided a method of operation for a battery pack, comprising communicating, by a battery management system of a battery pack via an external connection port thereof, battery operation data collected via at least one sensor of the battery pack to an external load via an external connection port.

The method can further comprise opening a contactor to shut down power provided by the battery pack when a control circuit through the external connection port is opened by the external load.

The method can further comprise receiving external load data from the external load via the external connection port, the external load data including a request, and modifying how power is provided by the battery pack to the external load at least partially in response to the request in the external load data.

In a further aspect, there is provided a battery pack, comprising a battery, an external connection port coupled to the battery to transmit power from the battery to an external load and transmit power from an external charger to the battery, and a battery management system coupled to the external connection port and conditioning the battery pack between a charging mode when the external connection port is connected to an external charger and a discharging mode when the external charger is undetected via the external connection port.

The battery management system can condition the battery pack between the discharging mode and the charging mode when a charger detection connector of the external connection port is connected to a ground contact of the external charger.

The external connection port can comprise a data communications interface and the battery management system can condition the battery pack to a charging mode when the external charger communicates an external device identifier message to the battery pack via the external connection port.

In yet another aspect, there is provided a method of operation for a battery pack, comprising detecting coupling of an external connection port of a battery pack to an external charger via a battery management system, conditioning, via the battery management system, the battery pack to a charging mode when the coupling of the external charger detection to the external connection port is detected, and conditioning, via the battery management system, the battery pack to a discharging mode when the coupling of the external charger to the external connection port is undetected.

The detecting can comprise detecting that a ground detection line of the second interface is connected to a ground contact of the external charger.

The detecting can comprise receiving an external device identifier message via the external connection port identifying an external charger.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 shows a side view of a battery pack in accordance with one embodiment thereof;

FIG. 2 is a front view of an external connection port of the battery pack of FIG. 1 for connecting to an external charger or an external load;

FIG. 3 is a schematic diagram showing various components of the battery pack of FIG. 1; and

FIG. 4 is a flowchart of the general method of operating the battery pack of FIG. 1.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

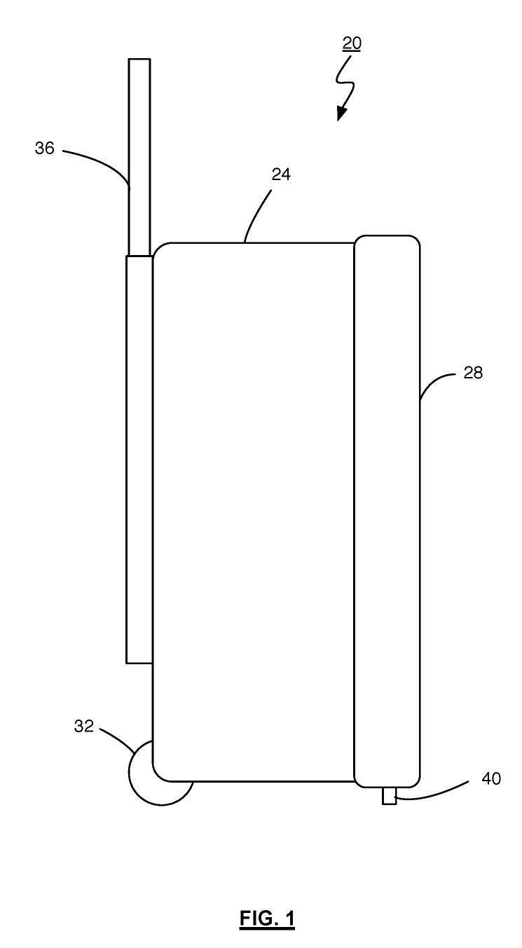

FIG. 1 shows a battery pack 20 in accordance with an embodiment. The battery pack 20 provides a number of features that collectively work to preserve the health of a lithium-ion battery, as well as that of a connected external load or external charger. A variety of conditions are monitored by the battery pack 20 in order to make intelligent decisions as to when to shut off or interrupt power flow. In addition, an external load can control the power being supplied by the battery pack 20. Further, the battery pack 20 can communicate battery operation data to the external load and receive external load data from the external load. The external load data can be used alone or in combination with the battery operation data collected by the battery pack 20 in making operation decisions. By using the battery operation data provided by various sensors and the external load data, the battery pack 20 can efficiently and safely manage its health. Any conditions outside of safe operating ranges defined via customizable parameters result in a shut off of the power circuit of the battery pack 20 or a change in performance characteristics until conditions return to within the safe operating ranges.

The battery pack 20 is portable and has a cuboid, ruggedized shell 24 and a hinged cover 28 that encloses various components of the battery pack 20 to protect them during transportation. Both the ruggedized shell 24 and the hinged cover 28 are composed primarily of a polycarbonate, but can also be composed of acrylonitrile butadiene tyrene, polyethylene terephthalate, nylon, or any other suitable material. As the battery pack 20 is designed to be portable, and as it weighs approximately 25 kilograms, it is equipped with a pair of wheels 32 at two adjacent corners of its bottom surface and an extendible handle 36 to facilitate transportation. A pair of feet 40 at opposite corners of its bottom surface enable the battery pack 20 to be rested levelly when not being transported.

The battery pack 20 contains a rechargeable battery and various components for managing the charging of the battery when connected to an external charger, and its discharging to an external load to which it may be coupled to provide power to the external load. Exemplary external loads include, for example, pneumatic compressors, lighting equipment, power tools, audio systems for music events, hydraulic pumps, electric motors, and variable frequency drives.

Battery operation data is collected and used by the battery pack 20 to manage operation of the battery, including controlling a smart external charger connected to the battery pack 20. In addition, some or all of the battery operation data can be communicated to an external load so that the external load can direct the battery pack 20 how to operate via battery operation commands. For example, a battery operation command can load may, depending on the battery operation data, direct the battery pack to reduce the provided voltage, amperage, power or activate support components such as heaters and cooling units, or activate visual warnings.

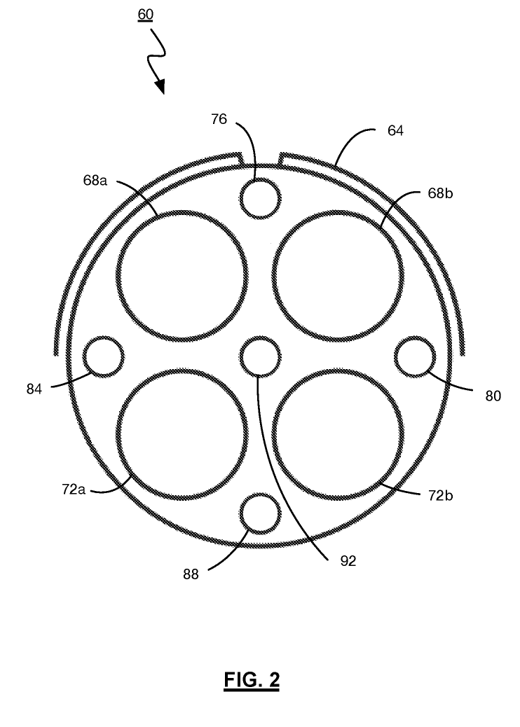

FIG. 2 shows an external connection port 60 of the battery pack of FIG. 1 that is accessible on the exterior of the battery pack 20. The external connection port 60 enables the battery pack 20 to be connected to an external charger or to an external load. A partial collar 64 facilitates correct alignment of a plug of an external load or charger with the external connection port 60. The external connection port 60 includes a pair of positive power connectors 68a and 68b and a pair of negative power connectors 72a and 72b. While two positive and negative power connectors are employed, it will be understood that a single positive power connector and a single negative power connector can be employed, or alternatively three or more positive and negative power connectors can be employed.

A signal output connector 76 and a signal input connector 80 enable an external load or external charger to control whether the power circuit coupled to the positive power connectors 68a and 68b and the negative power connectors 72a and 72b is opened or closed, thus enabling the external load to kill power supplied by the battery pack 20 when no power is needed by the external load. This reduces the risk of electrocution when the cables are cut.

A CAN-High connector 84 and a CAN-Low connector 88 enable bidirectional data communications with an external load or charger. Data communications via the CAN-High connector 84 and the CAN-Low connector 88 are conducted via a controller area network (“CAN”) using the CAN bus communications protocol. CAN is a multi-master serial bus standard for connecting devices without a host computer and enable bidirectional communications between the devices. The CAN bus communications protocol is one variant of a message-based protocol for use with a CAN, designed originally for multiplex electrical wiring within automobiles, but is also used in many other contexts. It is noted that other suitable communications protocols can be employed in place of the CAN bus communications protocol, such as OPEN-CAN.

A charger detection connector 92 is used by the battery pack 20 to detect the presence of an external charger.

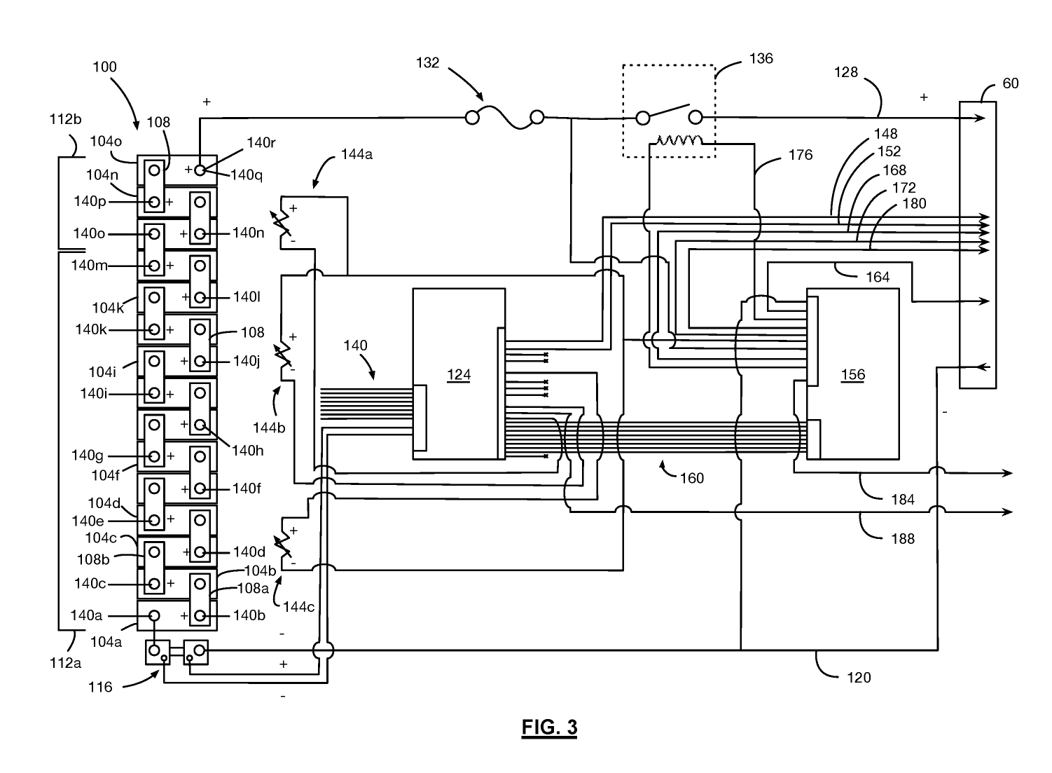

FIG. 3 is a schematic diagram showing a number of components of the battery pack 20. The battery pack 20 includes a battery 100, which is comprised of a set of battery cells, each of which is paralleled on a cell level, with two battery cells being placed in parallel to form a battery cell pair 104. The positive terminal of a first battery cell pair 104a being coupled to a negative terminal of a second battery cell pair 104b via a first interconnect 108a. In turn, the positive terminal of the second battery cell pair 104b is coupled to the negative terminal of a third battery cell pair 104c via a second interconnect 108b. The other displayed battery cell pairs 104 are all connected in series via interconnects 108 in a similar manner. The battery cells are positioned in a 15 in series and 2 in parallel configuration. That is, the battery cells are paralleled on a cell level, with two battery cells being placed in parallel then assembled into a 15 in series configuration. It will be understood that the configuration can be varied. For example, battery cells can be arranged 16 in series, two in parallel, 16 in series, one in parallel, or some other different configuration to achieve different voltages and energy capacities. By coupling the battery cells together, the battery cells effectively form a single battery. The battery cells are grouped into two cell groups 112a, 112b.

The negative terminal of the battery 100 (that is, the negative terminal of the first battery cell pair 104a in the battery 100) is coupled to a current shunt 116 that, in turn, is coupled to a negative lead 120 extending to the negative power connectors 72a and 72b of the external connection port 60 of FIG. 2. Other means for measuring amperage draw/acceptance include a Hall effect sensor.

A battery management system (“BMS”) 124 is coupled to the current shunt 116 to receive amperage data from the battery 100. The BMS 124 manages the operation of the battery pack 20, including the charging and discharging of the battery 100. In order to do so, the BMS 124 stores machine-executable instructions that, when executed by the BMS 124, cause the BMS 124 to monitor a variety of conditions, such as the operational temperature, load sensors, etc., and use a programmed custom set of parameters to determine if it is safe for the battery pack 20 to operate and to what degree of operational performance. The machine-executable instructions may be implemented in software, firmware, an application-specific integrated circuit, etc. The conditions monitored are referred to as battery operation data, and include battery condition data. Battery condition data can include, for example, temperature (for example, for each battery cell, between the battery cells, the battery 100 as a whole, and/or of the bms unit that measures the BMS internal board temperature), voltage across the entire battery 100, voltage across each battery cell, amperage draw during discharge, amperage accepted during charge, maximum battery voltage, and the internal resistance of each battery cell. Other battery operation data includes elevation, humidity, error notification, charge/discharge mode, faults list, ground fault protection, and outside temperature. Various sensors can be employed in the battery pack 20 to capture the battery operation data, including but not limited to thermal sensors, altimeters, voltage taps, and current shunts. External load data received from an external load via the external connection port 60 is also used by the BMS 124 to base its operating decision on both internal logic as well as external logic from connected equipment. During this process, the BMS 124 may calculate secondary data. Secondary data can include, for example, predicted operation time until empty, estimated life cycles to be achieved, heat build-up during operation, time to full charge, and time until pack achieves optimum charging or discharge temperature.

A positive lead 128 extends between the positive terminal of the last battery cell pair 104o and the positive power connectors 68a and 68b of the external connection port 60. A fuse 132 along the positive lead 128 is configured to break the power circuit in the case the current exceeds a pre-determined threshold of 400 amperes. The fuse amperage threshold can be varied as needed. In addition, a main contactor 136 can be conditioned to break and close the power circuit via the positive lead 128.

In order to determine the potential difference for each battery cell pair 104, a set of voltage taps 140a to 140r (collectively referred to herein as voltage taps 140) are connected to various terminals of the battery cell pairs 104 and extend to the BMS 124, enabling the BMS 124 to determine the potential difference for each battery cell pair 104 by comparing the voltage across sequentially adjacent voltage taps 140. For ease of viewing, the full lengths of the voltage taps 140 extending between the terminals of the battery cell pairs 104 and the BMS 124 are not presented in FIG. 3.

A set of three thermal sensors 144a, 144b, and 144c (collectively referred to hereinafter as thermal sensors 144) extending from the BMS 124 are positioned adjacent the battery cells and provide thermal data to the BMS 124. Any number of thermal sensors can be employed, depending on the application.

The BMS 124 has two data communication leads extending to the external connection port 60, a CAN-Low lead 148 coupled to the CAN-Low connector 88 and a CAN-High lead 152 coupled to the CAN-High connector 84. The potential difference across the CAN-Low lead 148 and the CAN-High lead 152 is used to convey data. The CAN-Low lead 148 and the CAN-High lead 152 enable the BMS 124 to send battery operation data to and receive external load data from the external load.

An auxiliary circuit board 156 accepts all auxiliary inputs and outputs not directly connected to the BMS 124. The auxiliary circuit board 156 controls power shut offs through control circuit relays that control the main contactor 136 and are controlled via the BMS 124, and the external load or external charger via the signal output connector 76 and the signal input connector 80 of the external connection port 60 or via CAN communications via the CAN-High connector 84 and the CAN-Low connector 88. The auxiliary circuit board 156 also provides a last resort shut off of the entire battery pack 20 in case the voltage falls to dangerously low levels. Converters on the auxiliary circuit board 156 provide voltage to a lower 12 VDC to power light-emitting diode (LED) backlights on a “fuel” (i.e., state-of-charge) gauge for the battery pack 20. The LED backlight is also controlled via the auxiliary circuit board and is designed to flash when the voltage of the battery 100 is in the reserve level. The LED backlight is shut off completely if any errors or faults occur, or if the battery is empty. The BMS 124 communicates with the auxiliary circuit board 156 via a set of internal communication leads 160 as to when to shut on or off relays, change the voltage being provided to an external load, or to control the electrical output, such as a flashing feature.

A signal output lead 164 and a signal return lead 168 extend from the auxiliary circuit board 156 to the signal output connector 76 and the signal input connector 80 respectively of the external connection port 60. The signal output lead 164 and the signal return lead 168 form a control circuit to control the main contactor 136 by opening and closing the control circuit, thereby enabling an external load or external charger to open and close the power circuit of the battery pack 20.

A ground detection line 172 extends between the auxiliary circuit board 156 and the ground detection connector 92 of the external connection port 60. When the BMS 124 detects that the ground detection line 172 is connected to a ground, it deems that an external charger is connected.

Fault detection is performed by the BMS 124 and may also be performed by an external load and external charger. For example, the BMS 124 can determine that the battery operating conditions as measured by the battery operating data fall outside of a safe operating range (e.g., the temperature may be too high), and that it is unsafe for the battery pack 20 and/or the external load or charger to continue operation of the battery pack 20. Upon detection of a fault, a signal may be sent to the main contactor 136 via the auxiliary circuit board 156 by the BMS 124 or an external load or charger to open the main contactor 136 and thus open the power circuit to prevent damage to the battery pack 20 and the external load or external charger. If the main contactor 136 fails, the fuse 132 opens the circuit if the fault is caused by too high of a current. Upon detecting that the fault is no longer present (such as by the BMS 124 determining that the battery operating conditions have returned to the safe operating range), the BMS 124 or the external load or external charger can direct the main contactor 136 to close the power circuit.

A state-of-charge (SoC) output line 180 and a SoC indicator line 184 extend from the auxiliary circuit board 156 to an external display of the battery pack 20 and enable state-of-charge data to be presented to the user. A state-of-charge (SoC) signal line 188 extends from the BMS 124 to an external light-emitting diode (LED) indicator on the exterior of the battery pack to provide a simplified manner to discern the operating condition of the battery pack 20.

The BMS 124 continually collects battery operation data during operation. The battery operation data collected includes thermal data from the thermal sensors 144, battery cell voltage data from the voltage taps 140, state of charge of the battery 100, cycle counts, internal resistance of each battery cell, historic faults, state of each output, input, contactor position, CAN messages, operating time, and the maximum and minimum values for various of these data.

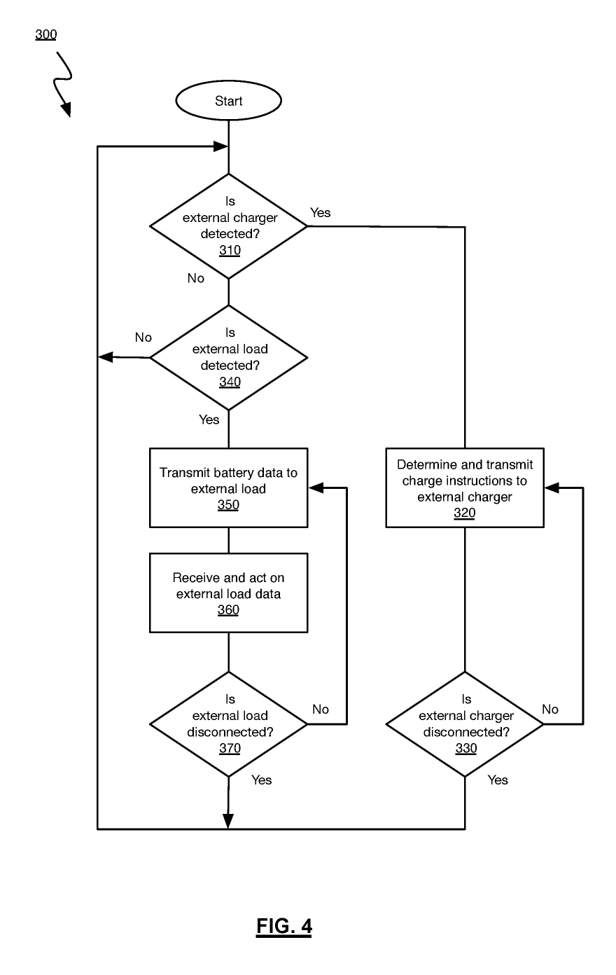

The general method 300 of operation of the battery pack 20 in conjunction with an external load or external charger will now be discussed with reference to FIG. 4. The battery pack 20 constantly determines if it is connected to an external charger (310). In particular, the auxiliary circuit board 156 determines if the ox of the external device connected to the charger detection connector 92 coupled to the ground detection line 172 is a ground. When the auxiliary board 156 detects that the charger detection connector 92 of the external connector 60 is grounded, it communicates this information to the BMS 124 which, in turn, switches the battery pack 20 to charging mode.

If it is determined that the battery pack 20 is connected to an external charger at 310, the BMS 124 determines and transmits charge instructions to the external charger (320). The BMS 124 looks at the collected battery operation data and uses a set of battery operation parameters to determine how the external charger should operate. In particular, the battery operation parameters enable the BMS 124 to determine, based on the state-of-charge and the temperature of the battery 100, and the amperage being accepted by the battery 100, a prescribed voltage and amperage that should be employed to charge the battery 100. For example, as the state-of-charge of the battery 100 approaches its maximum, the prescribed voltage remains fairly constant while the prescribed amperage decreases. If the temperature of the battery 100 increases, the prescribed amperage is dropped further. The BMS 124 determines the voltage and amperage to be provided by the external charger, and communicates them as charge instructions to the external charger.

At any time, the battery pack 20 can detect that the external charger is disconnected from the battery pack 20 (330). The battery pack 20 detects that the external charger is disconnected by detecting that the charger detection connector 92 coupled to the ground detection line 172 is no longer connected to a ground.

Upon detecting that the external charger is disconnected, the BMS 124 recommences detecting whether an external charger is connected at 310.

If the battery pack 20 deems that it is not connected to an external charger at 310, it determines whether it is connected to an external load (340). If the battery pack 20 is not in charging mode, it is constantly awaiting the closing of a circuit through the signal output connector 76 and the signal input connector 80 that indicates that an external load is connected and wants power from the battery pack 20. Upon the control circuit being closed through the signal input connector 76 and the signal output connector 80, a CAN communication is sent upon connection. In addition, assuming all battery parameters are in acceptable range, the main contactor 136 is closed and allows power to flow when the control circuit through the signal output connector 76 and the signal input connector is closed.

Upon detecting that the battery pack 20 is connected to an external load, the BMS 124 transmits battery operation data to the external load (350). In particular, the battery operation data transmitted by the BMS 124 via the external connection port 60 includes, amongst other items, the following: the number of battery cells, the voltage across the entire battery 100, the lowest, highest, and average voltage and resistance across each battery cell, the amperage draw during discharging, the thermal data captured via the thermal sensors 144, the estimated remaining battery operation time based on current usage, and the cooling fan speed. The battery operation data provided to an external load may be customized for the particular external load or may include all of the battery operation data that is shared by the battery pack 20. The external load may need to parse the battery operation data to retrieve particular data items in which it is interested.

Upon receiving the battery operation data from the battery pack 20, the external load can present some or all of the battery operation data to a user, such as via a display panel, one or more LEDs, a speaker, etc. The external load can modify its own behavior and operation in view of this data.

Next, external load data is received from the external load and acted upon by the BMS 124 (360). The external load may communicate data about its operation to the battery pack 20 continuously or in response to battery operation data received from the battery pack 20.

In addition, the external load can trigger a decision to limit or shut off power, torque, rpm, amperage, voltage, etc. as a result of any faults, a low state-of-charge, high or low temperatures, as well as any parameters approaching or falling outside of acceptable operating limits. The parameters can be provided by both the BMS 124 and the external load to make a decision either at the external load or at the battery pack 20, whichever is determined to be appropriate. The external load can effect the limiting or shutting off of power by communicating this information to the battery pack 20 as external load data via CAN communications using the CAN-High connector 84 and the CAN-Low connector 88. Alternatively, the external load can shut off power provided by the battery pack 20 by opening the control circuit through the signal output connector 76 and the signal input connector 80, thereby directly opening the main contactor 136 of the power circuit of the battery pack 20.

Upon receiving the external load data via the external connection port 60, the BMS 124 can modify its behavior in view of the external load data. In one example, the external load data can include a request to have the battery pack 20 throttle the voltage and/or amperage. The BMS 124 may, depending on its configuration, act on the request and throttle the voltage and/or amperage.

At any time, the battery pack 20 can detect that the external load is disconnected from the battery pack 20 (370). External loads are detected by the closure of the control circuit via the signal output connector 76 and the signal input connector 80. Removal of the external load from the external connection port 60, or the opening of the control circuit by the external load plugged into the external connection port 60 results in the BMS 124 determining that the external load is disconnected. For example, where the external load is a power saw and it detects that it has run into concrete, it can stop operation and open the control circuit to cause the battery pack 20 to cut power. In this case, the BMS 124 determines that the external load is “disconnected”.

Upon detecting that the external load is disconnected, the BMS 124 recommences detecting whether an external device is connected at 310.

The battery pack 20 is constantly on standby and sending out messages as well as listening for a response.

The battery pack 20 continuously operates in this manner.

While the data communications interfaces described above between the battery pack and external devices are bidirectional, two or more unidirectional communication data communications interfaces can be employed to enable the battery pack to communicate data to the external device and to receive communications from the external device.

While, in the above-described embodiment, battery operation data is transmitted to the external load via the same external connection port that is used to receive external load data from the external load, the sensor interface for providing sensor data to the external load can be separate from the external connection port. For example, the battery pack can have one or more external sensor ports that are separate from the external connection port for transmitting battery operation data to the external load and external charger.

The BMS 124 can alternatively generate and transmit charge instructions to an external charger as to which of a set of pre-defined charge stages to operate in. In one embodiment, three charge stages are pre-defined:
bulk charge, in which the external charger operates using the highest voltage and amperage that it is capable of;
absorption charge, in which the external charger charges the battery pack 20 at a steady voltage while the amperage declines, thus allowing continued charging of the battery 100 without overheating; and
float charge, in which the external charger generates the maximum voltage that the battery 100 can hold while dropping the amperage down to a trickle.

For example, if the battery state-of-charge is 65% and the temperature of the battery is within a standard operating range, then the BMS 124 directs the external charger to operate in a bulk charge mode.

The BMS can be a distributed BMS that has chips on each cell to control balancing and that are managed by a main “head” board.

While detection of the external charger is done analog in the above embodiment, detection of the external charger can be performed via an external device identifier message sent by the external charger via the data communications interface, or via some other communication that identifies the type of the external device.

The above-described embodiments are intended to be examples of the present invention and alterations and modifications may be effected thereto, by those of skill in the art, without departing from the scope of the invention that is defined solely by the claims appended hereto.

1. A battery pack, comprising:
a battery;
at least one sensor configured to read battery operation data;
an external connection port; and
a battery management system coupled to the external connection port and storing machine-executable instructions that, when executed, cause the battery management system to communicate battery operation data collected from the battery to an external load.

2. A battery pack according to claim 1, wherein the battery management system is coupled to at least one sensor positioned to sense battery operation data.

3. A battery pack according to claim 2, wherein the at least one sensor comprises a thermal sensor.

4. A battery pack according to claim 2, wherein the at least one sensor comprises a voltage tap.

5. A battery pack according to claim 2, wherein the at least one sensor detects one of an amperage draw during discharge and an amperage accepted during charging.

6. A battery pack according to claim 1, wherein the power provided by the battery pack can be shut down by the external load via the external connection port.

7. A battery pack according to claim 6, further comprising:
a contactor; and
a control circuit coupled to the contactor and the external connection port enabling the external load to control the contactor.

8. A battery pack according to claim 1, wherein the machine-executable instructions, when executed, cause the battery management system to receive external load data from the external load.

9. A battery pack according to claim 8, wherein the battery management system modifies its behavior in response to a request received in the external load data.

10. A battery pack according to claim 9, wherein the battery management system controls a voltage provided to the external load in response to the request.

11. A battery pack according to claim 9, wherein the battery management system controls a discharge amperage provided to the external load in response to the request.

12. A method of operation for a battery pack, comprising:
communicating, by a battery management system of a battery pack via an external connection port thereof, battery operation data collected via at least one sensor of the battery pack to an external load via an external connection port.

13. A method of operation for a battery pack according to claim 12, further comprising:
opening a contactor to shut down power provided by the battery pack when a control circuit through the external connection port is opened by the external load.

14. A method of operation for a battery pack according to claim 12, further comprising:
receiving external load data from the external load via the external connection port, the external load data including a request; and
modifying how power is provided by the battery pack to the external load at least partially in response to the request in the external load data.

15. A battery pack, comprising:
a battery;
an external connection port coupled to the battery to transmit power from the battery to an external load and transmit power from an external charger to the battery; and
a battery management system coupled to the external connection port and conditioning the battery pack between a charging mode when the external connection port is connected to an external charger and a discharging mode when the external charger is undetected via the external connection port.

16. A battery pack according to claim 15, wherein the battery management system conditions the battery pack between the discharging mode and the charging mode when a charger detection connector of the external connection port is connected to a ground contact of the external charger.

17. A battery pack according to claim 15, wherein the external connection port comprises a data communications interface and wherein the battery management system conditions the battery pack to a charging mode when the external charger communicates an external device identifier message to the battery pack via the external connection port.
